(19) United States
(12) Patent Application Publication
(10) Pub. No.: US 2010/0182668 A1
(43) Pub. Date: Jul. 22, 2010

(54) Projection Image Display Apparatus

(75) Inventors: Takaaki ABE, Osaka (JP); Masutaka INOUE, Osaka (JP); Susumu TANASE, Osaka (JP); Yoshinao HIRANUMA, Osaka (JP); Tomoya TERAUCHI, Osaka (JP); Masahiro HARAGUCHI, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/688,484

(22) Filed: Jan. 15, 2010

(30) Foreign Application Priority Data
Jan. 16, 2009 (JP) 2009-008066
Jan. 20, 2009 (JP) 2009-010430

(51) Int. Cl. G02B 26/10; G03B 21/00; G03B 21/20

(52) U.S. Cl. 359/202.1; 353/122; 353/85

(57) ABSTRACT

A projection image display apparatus includes a solid light source, and a projection element configured to scan a projection plane with spot light emitted from the solid light source. The projection image display apparatus includes an element controller configured to control a scanning speed of the projection element on the basis of an image input signal; and a signal corrector configured to correct the image input signal on the basis of the scanning speed of the projection element controlled by the element controller.

### CROSS REFERENCE TO RELATED APPLICATIONS

This application is based upon and claims the benefit of priority from prior Japanese Patent Application No. 2009-008066, filed on Jan. 16, 2009, and prior Japanese Patent Application No. 2009-010430, filed on Jan. 20, 2009; the entire contents of which are incorporated herein by reference.

### BACKGROUND OF THE INVENTION

1. Field of the Invention

The present invention relates to a projection image display apparatus including a projection element configured to scan a projection plane with light emitted from a solid light source.

2. Description of the Related Art

Heretofore, there has been known a projection image display apparatus including a projection element configured to scan a projection plane with spot light emitted from a solid light source. One of possible ways to improve the quality of an image projected on a projection plane is to increase the image resolution (for example, Japanese Patent Application Publication No. 2006-343397).

For facsimiles and digital copying machines, there has also been known a technique of recording information on a scan surface by scanning the scan surface with spot light (for example, Japanese Patent Application Publication No. Heisei 5-107496). Specifically, according to such a technique, the spot diameter of the spot light is reduced to increase gradation.

However, an image projected on a projection plane has a fixed number of pixels (dots) in a scanning direction, and is set to a desired size. Thus, simply reducing the spot diameter by diverting the above-mentioned technique does not lead to an increase of the resolution.

### SUMMARY OF THE INVENTION

A first aspect of a projection image display apparatus includes a solid light source, and a projection element configured to scan a projection plane with spot light emitted from the solid light source. The projection image display apparatus includes an element controller configured to control a scanning speed of the projection element on the basis of an image input signal; and a signal corrector configured to correct the image input signal on the basis of the scanning speed of the projection element controlled by the element controller.

In the first aspect, the projection image display apparatus further includes a light source controller configured to control a spot diameter of spot light to be emitted from the solid light source, on the basis of the scanning speed of the projection element controlled by the element controller.

In the first aspect, the projection image display apparatus further includes an identifying unit configured to identify a high-frequency region in an image on the basis of the image input signal. The high-frequency region is a region including a high-frequency component. A reference scanning speed is set for the scanning speed of the projection element. The element controller controls the scanning speed of the projection element lower than the reference scanning speed in the high-frequency region, and controls the scanning speed of the projection element higher than the reference scanning speed outside the high-frequency region.

In the first aspect, the projection image display apparatus further includes a light source controller configured to control a spot diameter of spot light to be emitted from the solid light source, on the basis of the scanning speed of the projection element controlled. by the element controller. The light source controller reduces the spot diameter of the spot light to be emitted from the solid light source, in the high-frequency region.

In the first aspect, the projection element includes a horizontal-scanning projection element which scans the projection plane in a horizontal direction with the spot light emitted from the solid light source, and a vertical-scanning projection element which scans the projection plane in a vertical direction with the spot light emitted from the solid light source. The element controller controls a first mode in which the horizontal-scanning projection element performs main scanning and the vertical-scanning projection element performs sub scanning, and a second mode in which the vertical-scanning projection element performs the main scanning and the horizontal-scanning projection element performs the sub scanning.

In the first aspect, the projection image display apparatus further includes an image analyzer configured to acquire distribution of brightness in an image, on the basis of the image input signal. The image analyzer selects any one of the first mode and the second mode in accordance with the distribution of brightness. The element controller controls the horizontal-scanning projection element and the vertical-scanning projection element in accordance with the mode selected by the image analyzer.

In the first aspect, when a black region spreads in the horizontal direction in the image, the image analyzer selects the first mode. When a black region spreads in the vertical direction in the image, the image analyzer selects the second mode.

In the first aspect, the image analyzer specifies a representative value of brightness in each of a plurality of band-shaped regions extending horizontally in the image in the first mode, and specifies a representative value of brightness in each of a plurality of band-shaped regions extending vertically in the image in the second mode. The element controller controls the sub scanning of the vertical-scanning projection element in accordance with a ratio between the representative values of brightness in the plurality of band-shaped regions extending horizontally in the first mode. The element controller controls the sub scanning of the horizontal-scanning projection element in accordance with a ratio between the representative values of brightness in the plurality of band-shaped regions extending vertically in the second mode.

In the first aspect, the image analyzer specifies a valid display region and an invalid display region in a projectable display region which is a region of the projection plane scannable with the spot light by the projection element. The element controller controls the projection elements so that the projection elements scan the valid display region in the projectable display region excluding the invalid display region.

In the first aspect, when the projection elements are controlled to scan the valid display region except the invalid display region, the signal corrector removes the image input signal corresponding to the invalid display region and performs interpolation on the image input signal corresponding to the valid display region.

In the first aspect, the element controller switches between the first mode and the second mode frame by frame.

### BRIEF DESCRIPTION OF THE DRAWINGS

FIG. 1 is a diagram showing a projection image display apparatus 100 according to a first embodiment.

FIG. 2 is a diagram showing scanning by a projection element 10 according to the first embodiment.

FIG. 3 is a diagram showing a filter according to the first embodiment.

FIG. 4 is a graph showing a scanning speed control coefficient α according to the first embodiment.

FIG. 5 is a graph for explaining the scanning speed of the projection element 10 according to the first embodiment.

FIG. 6 is a graph showing a spot diameter according to the first embodiment.

FIG. 7 is a diagram showing a basic configuration of a projection image display apparatus 400 according to a second embodiment.

FIG. 8 is a diagram showing a circuit configuration of the projection image display apparatus 400 according to the second embodiment.

FIGS. 9A to 9D are an image, a diagram and graphs, respectively, for explaining a first mode according to the second embodiment.

FIGS. 10A to 10D are an image, a diagram and graphs, respectively, for explaining a second mode according to the second embodiment.

FIG. 11 is a flowchart for explaining image analysis processing by an image analyzer 350 according to the second embodiment.

FIGS. 12A and 12B are diagrams for explaining black band regions according to the second embodiment.

FIG. 13 is a diagram for explaining processing to divide an image into multiple regions and processing to specify highest luminance values respectively of horizontal bands and highest luminance values respectively of vertical bands, according to the second embodiment.

FIG. 14 is a flowchart for explaining image correction processing by an image corrector 360, according to the second embodiment.

FIG. 15 is a table showing an example of calculation of a power assignment P and a signal gain G for each band, according to the second embodiment.

FIG. 16 is a flowchart for explaining drive processing for a horizontal-scanning projection element by a projection element controller, according to the second embodiment.

FIG. 17 is a graph for explaining an oscillation angle ω of a projection element responsible for sub scanning, according to the second embodiment.

FIGS. 18A to 18D are an image, a diagram and graphs, respectively, for explaining mode switching according to a modification.

### DETAILED DESCRIPTION OF TUE EMBODIMENTS

Hereinbelow, a projection image display apparatus according to embodiments of the present invention will be described with reference to the drawings. In the drawings below, the same or similar portions are denoted by the same or similar reference numerals.

However, it should be noted that the drawings are schematic and dimensional proportions and the like are different from actuality. Therefore, concrete dimensions and the like should be determined in consideration of the following description. Moreover, needless to say, dimensional relations and proportions may be mutually different among the drawings in some parts.

### [Outline of Embodiments]

The projection image display apparatus according to each of the embodiments include a solid light source and a projection element configured to scan a projection plane with spot light emitted from the solid light source. The projection image display apparatus also includes an element controller configured to control the scanning speed of the projection element on the basis of image input signals, and a signal corrector configured to correct the image input signals on the basis of the scanning speed, of the projection element, controlled by the element controller.

In the embodiments, the element controller controls the scanning speed of the projection element on the basis of image input signals. Moreover, the signal corrector corrects the image input signals on the basis of the scanning speed of the projection element. Accordingly, resolution can be increased, and thus the quality of an image to be projected on a projection plane can be improved.

### First Embodiment

### Configuration of Projection Image Display Apparatus

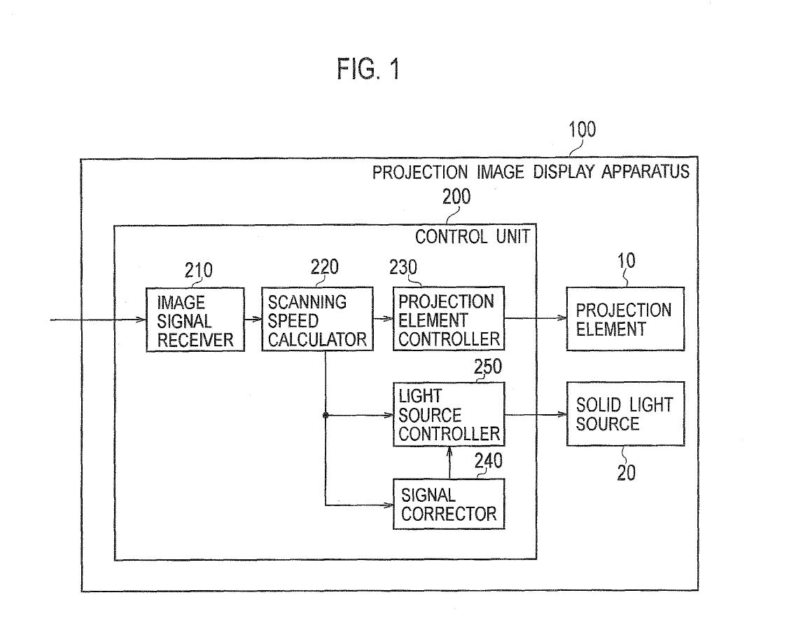

A projection image display apparatus according to a first embodiment will be described below with reference to the drawings. FIG. 1 is a diagram showing a projection image display apparatus 100 according to the first embodiment.

As shown in FIG. 1, the projection image display apparatus 100 includes a projection element 10, a solid light source 20, and a control unit 200.

The projection element 10 is configured to scan a projection plane (not shown) with spot light emitted from the solid light source 20. Note that, for the scanning speed of the projection element 10, a reference scanning speed is determined, in advance in accordance with the size of an image to be projected on the projection plane.

For example, the projection element 10 scans the projection plane in a y-axis direction (vertical direction) with spot light beams as shown in FIG. 2. In FIG. 2, the projection plane is defined by an x axis in a horizontal direction and a y axis in the vertical direction. Incidentally, the scanning direction of the projection element 10 is not limited to the y-axis direction (vertical direction), and may be the x-axis direction (horizontal direction).

The solid light source 20 is a solid light source, such as a laser diode (LD). The solid light source 20 is formed of a red solid light source, a green solid light source, and a blue solid light source. The red solid light source is configured to emit red spot light. Likewise, the green solid light source is configured to emit green spot light, and the blue solid light source is configured to emit blue spot light. Incidentally, the solid light source of each color may be an array light source formed of multiple solid light sources.

The control unit 200 is configured to control components provided in the projection image display apparatus 100. Specifically, the control unit 200 includes an image signal receiver 210, a scanning speed calculator 220, a projection element controller 230, a signal corrector 240, and a light source controller 250.

The image signal receiver 210 is configured to acquire an image input signal for each of multiple pixels constituting one frame (image), from an external device, such as a DVD player or a TV tuner. The image input signal includes a red input signal R, a green input signal G, and a blue input signal B.

The scanning speed calculator 220 is configured to calculate the scanning speed of the projection element 10 on the basis of the image input signals. Specifically, the scanning speed calculator 220 identifies a region where the resolution should be increased (hereinbelow, a high-frequency region), and then calculates the scanning speed of the projection element 10 on the basis of the high-frequency region.

Firstly, the scanning speed calculator 220 extracts a pixel having a high-frequency component, on the basis of image input signals. The scanning speed calculator 220 then identifies a region including the pixel having the high-frequency component, as a high-frequency region. In other words, a high-frequency region is a region which includes a high-frequency component in one frame (image).

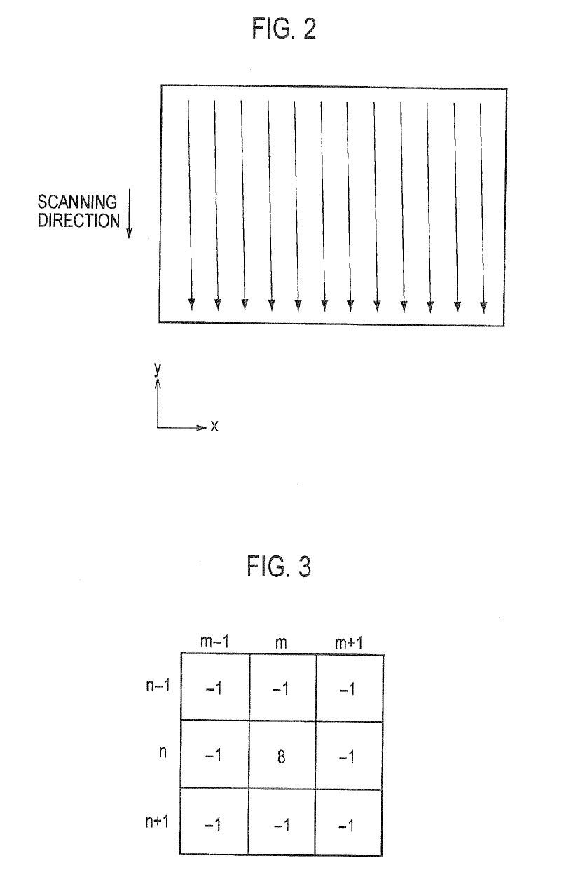

The scanning speed calculator 220 calculates a frequency component F(m, n) of a target pixel(m, n), using a filter shown in FIG. 3, for example. Values shown in FIG. 3 are coefficients by which pixel values of a pixel(m−1, n−1) to a pixel(m+1, n+1) are multiplied, respectively.

F(m, n)=8×PV(m, n)−1×PV(m−1, n−1)−1×PV(m, n−1)−1×PV(m+1, n−1)−1×PV(m−1, n)−1×PV(m+1, n)−1×PV(m−1, n+1)−1×PV(m, n+1)−1×PV(m+1, +1) [Formula 1]

where PV(x, y) is the value of a pixel having coordinates (x, y).

Here, the scanning speed calculator 220 extracts the target pixel(m, n) as a pixel having a high-frequency component, when the frequency component F(m, n) is larger than a predetermined threshold.

Note that the method of extracting a pixel having a high-frequency component is not limited to the method using the filter shown in FIG. 3, and a frequency analysis method using Fourier transform may be used instead.

Secondly, the scanning speed calculator 220 acquires a scanning speed control coefficient α on the basis of the frequency component values of the pixels included in the high-frequency region (hereinbelow, a high-frequency-component value). Note that the high-frequency-component value is an average frequency-component value of the pixels included in the high-frequency region, for example. In addition, the scanning speed control coefficient α is a coefficient to lower the scanning speed of the projection element 10. The scanning speed control coefficient α takes a value within a range from a minimum value MIN (>0) to a maximum value MAX (=1).

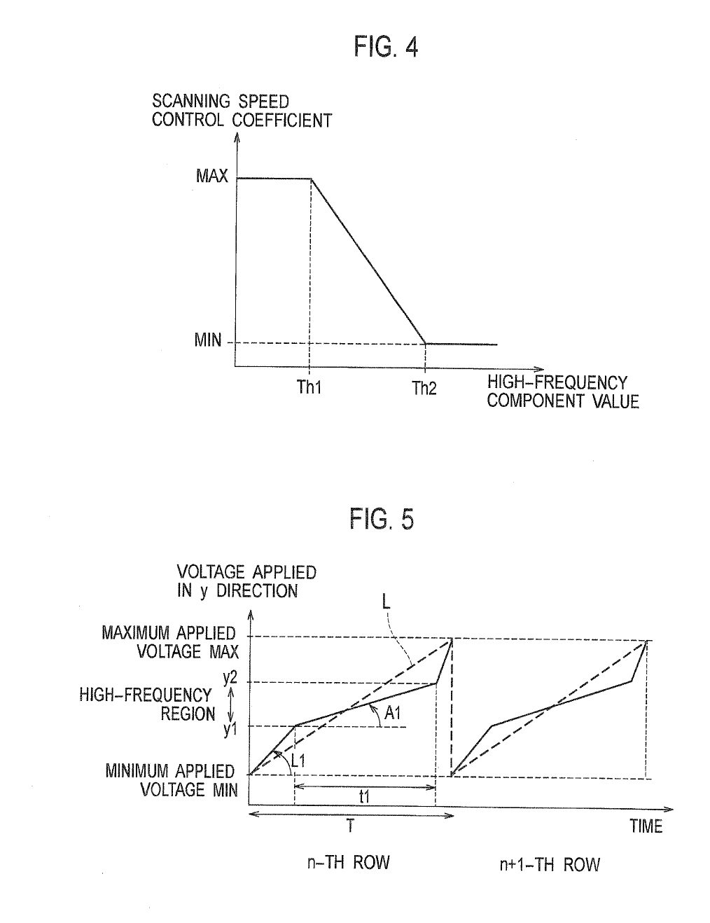

The scanning speed calculator 220 acquires the scanning speed control coefficient α on the basis of a relationship shown in FIG. 4, for example. As shown in FIG. 4, when the high-frequency component value is smaller than a threshold Th1, the scanning speed control coefficient α is always at the maximum value MAX. When the high-frequency component value is larger than a threshold Th2, the scanning speed control coefficient α is always at the minimum value MIN. Between the thresholds Th1 and Th2 inclusive, the scanning speed control coefficient α lowers with the increase of the high-frequency component value.

Thirdly, the scanning speed calculator 220 calculates the scanning speed of the projection element 10 on the basis of the scanning speed control efficient α. Specifically, the scanning speed calculator 220 calculates the scanning speed of the projection element 10 outside the high-frequency region and the scanning speed of the projection element 10 inside the high-frequency region. Here, the ratio of the scanning speed of the projection element 10 outside the high-frequency region to the scanning speed of the projection element 10 inside the high-frequency region is maintained to be the maximum value MAX (=1): the scanning speed control coefficient α.

For example, based on the following equations, the scanning speed calculator 220 calculates the scanning speed (A1) of the projection element 10 outside the high-frequency region and the scanning speed (L1) of the projection element 10 inside the high-frequency region.

L=(MAX−MIN)/T

a1=L×α

t1=(y2+y1)/a1

te=T−t1

C=(MAX−MIN)/(y2−y1+te×L)

A1=a1×C

L1=L×C [Formula 2]
L: Predetermined reference scanning speed
MAX: Maximum voltage to be applied in y-axis direction
MIN: Minimum voltage to be applied in y-axis direction
T: y-axis direction scanning time in one frame (one row)
a1: Tentative scanning speed in high-frequency region
t1: Tentative scanning time in high-frequency region
y1, y2(>y1)=Voltage values corresponding to coordinates of boundaries between high-frequency region and region outside high-frequency region
te: Tentative scanning time in region outside high-frequency region
C: Scanning-time adjustment coefficient

The relationship among L, L1, and A1 is shown in FIG. 5. It should, be noted that the slope of each of L, L1, and A1 shown in FIG. 5, i.e., the rate of increase of the voltage to be applied in the y-axis direction, corresponds to the scanning speed of the projection element 10.

The projection element controller 230 is configured to control the projection element 10. Specifically, the projection element controller 230 controls the projection element 10 so that scanning can be performed at the scanning speed (A1) in the high-frequency region. In contrast, the projection element controller 230 controls the projection element 10 so that scanning can be performed at the scanning speed (L1) outside the high-frequency region.

The signal corrector 240 is configured to correct the image input signals on the basis of the scanning speed of the projection element 10. For example, the signal corrector 240 performs thinning processing on pixels in the y-axis direction (vertical direction) or interpolation processing on the pixels in the y-axis direction (vertical direction). Specifically, the signal corrector 240 performs the thinning processing on the pixels outside the high-frequency region on the basis of the scanning speed (L1) since the scanning speed (L1) is faster (higher) than the reference scanning speed (L). In contrast, the signal corrector 240 performs the interpolation processing on the pixels in the high-frequency region on the basis of the scanning speed (A1) since the scanning speed (L1) is the scanning speed (A1) is slower (lower) than the reference scanning speed (L).

The light source controller 250 is configured to control the solid light source 20. Firstly, the light source controller 250 controls the intensity of the spot light to be emitted from the solid light source 20, on the basis of the image input signals having been corrected by the signal corrector 240. Secondly, the light source controller 250 controls the spot diameter of the spot light to be emitted from the solid light source 20, on the basis of the scanning speed of the projection element 10.

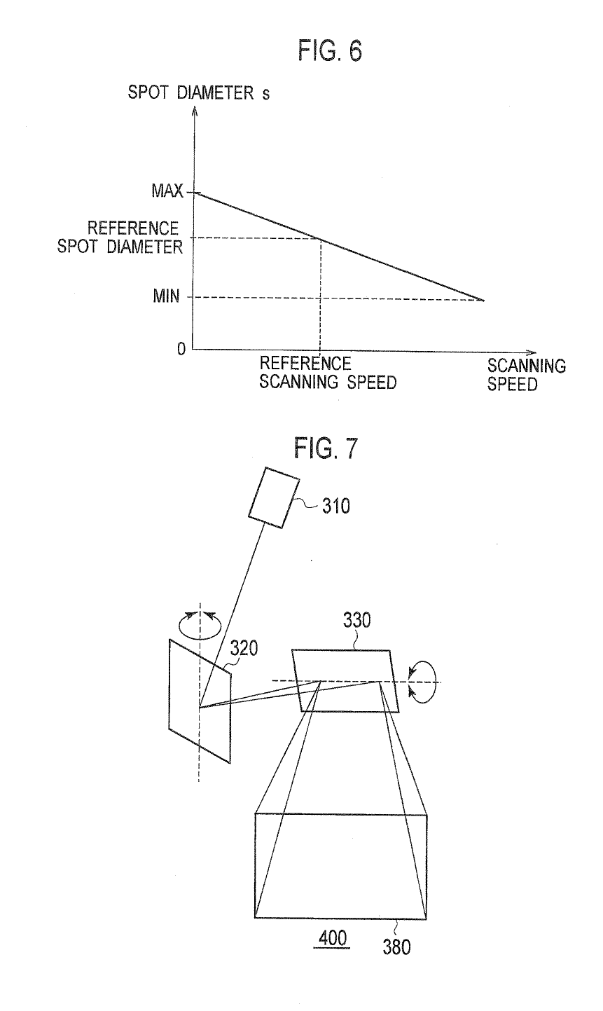

Specifically, the light source controller 250 controls the spot diameter of the spot light to be emitted from the solid light source 20, in accordance with a relationship shown in FIG. 6. As shown in FIG. 6, the faster the scanning speed, the smaller the spot diameter.

That is, the light source controller 250 sets the spot diameter of the region outside the high-frequency region to be larger than a reference spot diameter since the scanning speed (L1) is faster than the reference scanning speed (L). In contrast, the light source controller 250 sets the spot diameter smaller to be smaller than the reference spot diameter for the high-frequency region since the scanning speed (A1) is slower than the reference scanning speed (L). Note that the reference spot diameter is a spot diameter used. for the reference scanning speed (L).

### (Advantageous Effect)

In the first embodiment, the projection element controller 230 controls the scanning speed of the projection element 10 by using the scanning speeds (L1, A1) calculated based on image input signals. Moreover, the signal corrector 240 corrects the image input signals on the basis of the scanning speed of the projection element 10. Accordingly, the resolution can be increased, and thus the quality of an image to be projected on the projection plane can be improved.

Specifically, in the first embodiment, the scanning speed of the projection element 10 is controlled so that the scanning is performed at the scanning speed (A1), which is slower than the reference scanning speed (L), in a high-frequency region. Accordingly, the resolution is increased in the high-frequency region, and thus the quality of the image to be projected on the projection plane can be improved.

Meanwhile, the scanning speed of the projection element 10 is controlled so that scanning is performed at the scanning speed (L1), which is faster than the reference scanning speed (L), outside the high-frequency region. Accordingly, the resolution is reduced outside the high-frequency region. Nonetheless, inter-pixel gaps are small in the region outside the high-frequency region, so that the quality of the whole image is less likely to be deteriorated.

In the first embodiment, the light source controller 250 controls the spot diameter of spot light to be emitted from the solid light source 20, on the basis of the scanning speed of the projection element 10. This enhances the effect of increasing the resolution.

Specifically, in the first embodiment, the spot diameter is smaller than the reference spot diameter in the high-frequency region since the scanning speed (A1) is slower than the reference scanning speed (L). In contrast, the spot diameter is larger than the reference spot diameter outside the high-frequency region since the scanning speed (L1) is slower than the reference scanning speed (L). This enhances the effect of increasing the resolution in the high-frequency region.

### Modified Embodiments

The present invention has been described based on the above embodiment; however, it should not be understood that the statements and the drawings constituting a part of this disclosure limit the invention. From this disclosure, various alternative embodiments, examples, and operation techniques should be apparent to those skilled in the art.

In the first embodiment, the laser diode (LD) is raised as an example of the solid light source. However, the solid light source may be a light emitting diode (LED).

In the first embodiment, a component to change the spot diameter is not mentioned. Change in spot diameter may be achieved by au apparatus including a variable aperture element and, being configured to vary the diameter of a flux of light as described in Japanese Patent Application Publication No. Heisei 5-107496.

In the first embodiment, a case where there is only one high-frequency region is illustrated, but the embodiment is not limited to such a case. Specifically, the scanning speed of the projection element 10 may be calculated for each of multiple high-frequency regions. For example, in a case of having a high-frequency region #1 and a high-frequency region #2, the scanning speeds of the projection elements 10 are calculated based on the following equations.

L=(MAX−MIN)/T

a1=L×α1

a2=L×α2

t1=(y2−1)/a1

t2(y4−y3)/a1

te=T−(t+t2)

C=(MAX−MIN)/((y2−y1)+(y4−y3)+te×L)

A1=a1×C

A2=a1×C

L1=L×C [Formula 3]
a1: Tentative scanning speed in high-frequency region #1
t1: Tentative scanning time in high-frequency region #1
a2: Tentative scanning speed in high-frequency region #2
t2: Tentative scanning time in high-frequency region #2
y1, y2(>y1)=Coordinates on y-axis representing boundaries between high-frequency region #1 and region outside high-frequency region #1
y3, y4(>y3)=Coordinates on y-axis representing boundaries between high-frequency region #2 and region outside high-frequency region #2
te: Tentative scanning time in region outside high-frequency regions
A1: Scanning speed in high-frequency region #1
A2: Scanning speed in high-frequency region #2

### Second Embodiment

A second embodiment will be described below with reference to the drawings. Differences from the first embodiment will be mainly described below.

Specifically, in the second embodiment, spot light emitted from a light source is scanned along two axes in horizontal and vertical directions. Moreover, a projection image display apparatus of the second embodiment has two modes that depend on which one of the horizontal and vertical directions serves as the main scanning direction.

FIG. 7 is a diagram showing a basic configuration of a projection image display apparatus 400 according to the second embodiment. The projection image display apparatus 400 is a two-axis-scanning laser projector of a direct imaging or backlight type. The projection image display apparatus 400 includes a light source 310, a horizontal-scanning projection element 820, and a vertical-scanning projection element 330, as its main elements. Spot light emitted from the light source 310 is reflected by the horizontal-scanning projection element 320 and the vertical-scanning projection element 330 in this order or in the opposite order, and then guided to a projection plane 380, such as a screen or a wall. Hereinbelow, in the second embodiment, an example will be described in which the reflection occurs on the horizontal-scanning projection element 320 and the vertical-scanning projection element 330 in this order.

The light source 310 is a solid light source, such as a laser diode (LD). For example, the light source 310 is configured to emit red spot light, green spot light, and blue spot light individually.

The horizontal-scanning projection element 320 is an element (mirror) capable of oscillating in the horizontal direction. The horizontal-scanning projection element 320 scans the projection plane in the horizontal direction with spot light emitted from the light source 310. The vertical-scanning projection element 330 is an element (mirror) capable of oscillating in the vertical direction. The vertical-scanning projection element 330 scans the projection plane in the vertical direction with the spot light emitted from the light source 310. The horizontal-scanning projection element 320 and the vertical-scanning projection element 330 each include a mirror, a magnet, and a current line. The magnet and the current line are disposed respectively at predetermined positions according to the oscillation direction of the mirror. When a current flows in the current line, a Lorenz force is generated, which in turn causes the mirror to move in a predetermined oscillation direction. A projection element controller 340 to be described later controls the amount and the direction of the current to be flowed in the current line, so that the movements of the horizontal-scanning projection element 320 and the vertical-scanning projection element 330 are controlled.

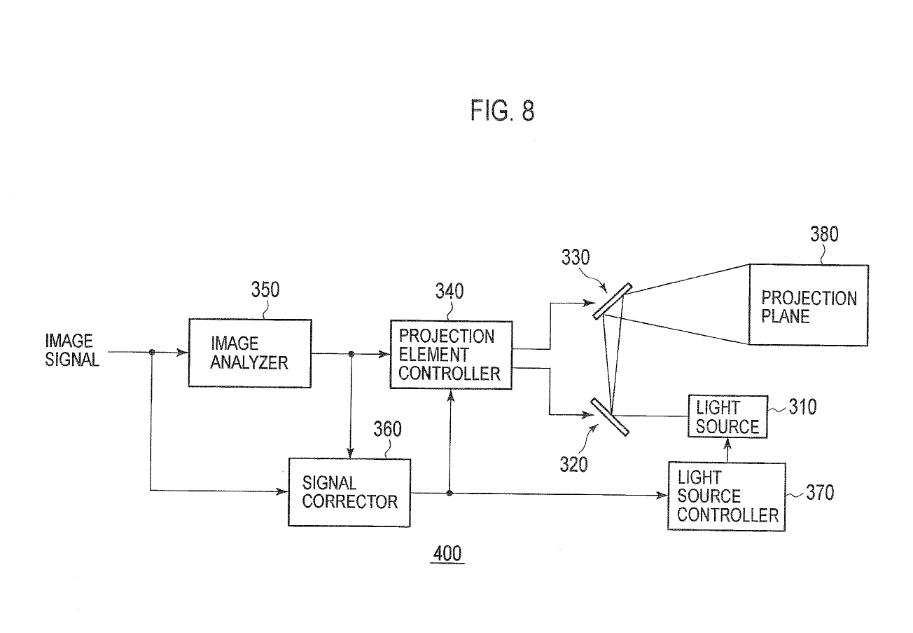

FIG. 8 is a diagram showing a circuit configuration of the projection image display apparatus 400 according to the second embodiment. The projection image display apparatus 400 includes the light source 310, the horizontal-scanning projection element 320, the vertical-scanning projection element 330, the projection element controller 340, an image analyzer 350, a signal corrector 360, and a light source controller 370. The configuration of the projection element controller 340, the image analyzer 350, the signal corrector 360, and the light source controller 370 may be implemented as hardware by using any processor, memory, driving element, or some other LSI, or as software by using a program loaded onto a memory, or the like. What are illustrated herein are functional blocks implemented by interaction among those. Accordingly, it is to be understood by those skilled in the art that these functional blocks can be implemented in various forms by only using hardware or software, or using combinations of both.

The light source 310 is configured to sequentially emit spot light beams corresponding to pixel signals included in image input signals. More specifically, the light source controller 370 determines the amount of light to be emitted at the position of each pixel, in accordance with a corresponding pixel signal included in an image signal having been corrected by the signal corrector 360. Then, the light source controller 370 sets the light amounts to the light source 310. In accordance with the set light amounts, the light source 310 emits the respective spot light beams. Note that the direction in which the light source 310 emits the spot light beams is fixed, and the projection positions for the spot light beams on the projection plane are controlled by the horizontal-scanning projection element 320 and the vertical-scanning projection element 330.

The horizontal-scanning projection element 320 reflects spot light emitted from the light source 310. The vertical-scanning projection element 330 reflects the spot light reflected. by the horizontal-scanning projection element 320 and then guides the spot light to the projection plane 80. The light projected momentarily on the projection plane 80 corresponds to only one pixel; however, the light is scanned at such a high speed that the afterimage effect of the eyes occurs, and thus is recognized as a picture.

The projection element controller 340 is configured to switch between a first mode and a second mode. In the first mode, the main scanning of the spot light is performed by the horizontal-scanning projection element 320, and the sub scanning thereof is performed by the vertical-scanning projection element 330. In the second mode, the main scanning of the spot light is performed by the vertical-scanning projection element 330, and the sub scanning thereof is performed by the horizontal-scanning projection element 320. In this description, of the horizontal direction and the vertical direction of an image, one in which fast scanning is performed is referred to as the main scanning direction and scanning in this direction is referred to as main scanning, while one in which slow scanning is performed is referred to as a sub scanning direction and scanning in this direction is referred to as sub scanning.

The projection element controller 340 is capable of switching between the first made and the second mode in accordance with an instruction from the image analyzer 350. Incidentally, the mode switching may be made in accordance with a mode select signal from an unillustrated operation unit attributable to a user's operation thereof. Alternatively, the mode switching between the two modes may be made every time a set period of time elapses.

The projection element controller 340 performs control so as to regularly oscillate the horizontal-scanning projection element 820 or the vertical-scanning projection element 330, whichever is responsible for the main scanning with the spot light. For example, the horizontal-scanning projection element 320 or the vertical-scanning projection element 330 is caused to operate at a resonance frequency. It is necessary to move the mirror surface at a high speed in the main scanning direction. Thus, the projection element responsible for the main scanning is not subjected to such detailed control as changing the oscillation of its mirror surface for each line in an image.

The projection element controller 340 controls the horizontal-scanning projection element 320 or the vertical-scanning projection element 330, whichever is responsible for the sub scanning with the spot light, in such a way to change the direction of its mirror surface in accordance with time ratios based on ratios between representative luminance values respectively of multiple band regions divided in the sub scanning direction of the image. The time ratios can be set by the signal corrector 360. A period of time between synchronizing signals of the image or example, 16.6 msec) is given when scanning in the sub scanning direction is performed one time. Therefore, more detailed control is performed on the projection element responsible for the sub scanning. The control to be performed on the projection element responsible for the sub scanning will be described later in detail.

Firstly, the image analyzer 350 analyzes image input signals inputted from an unillustrated recording medium or communication medium via an unillustrated buffer, and figures out the distribution of the brightness in an image produced by the image input signals. Based on the distribution, the image analyzer 350 selects either the first mode or the second mode. Here, the brightness may be a luminance value, a brightness value, or the image input signal itself (highest value of each of RGB or the like). The image analyzer 350 then sets the projection element controller 340 and the signal corrector 360 in the selected mode. Of the horizontal direction and the vertical direction of an image, the image analyzer 350 for example specifies one in which the brightness (for example, luminance levels) is leveled more. The image analyzer 350 selects the first mode if the brightness is leveled more in the horizontal direction of the image, whereas selecting the second mode if the brightness is leveled more in the vertical direction. Here, the direction in which the brightness is leveled may be a direction in which a pixel group (black region) of lower brightness than a predetermined reference value spreads. In the following, description will be given of an example where, of the horizontal direction and the vertical direction of an image, one in which a pixel group (black region) of lower brightness than a predetermined reference value spreads.

As an example of specifying a direction in which a black region spreads, the image analyzer 850 specifies whether pixels each having a luminance value lower than a predetermined reference value in an image spreads in the horizontal direction or in the vertical direction. The reference value is set to zero or a value close to zero. In other words, specified is whether substantially-black pixels in an image are continuously spread in the horizontal direction or in the vertical direction.

For that specification, the image analyzer 850 horizontally and vertically divides the image into multiple band regions (hereinbelow, referred to as bands), and then specifies the representative brightness value (for example, highest luminance value) of each of the bands. Thereafter, the image analyzer 350 calculates the lowest value among the representative values of the multiple bands for each direction, and compares the lowest value in the horizontal direction and the lowest value in the vertical direction. The image analyzer 350 selects the second mode if the former is larger than the latter, whereas selecting the first mode if the former is equal to or smaller than the latter.

Secondly, the image analyzer 350 specifies a valid display region formed of valid pixels and an invalid display region formed of invalid pixels, in a projectable display region of the projection plane scannable with the spot light by the projection elements (horizontal-scanning projection element 320 and vertical-scanning projection element 830). For example, the invalid display region is formed when there is a difference between the aspect ratio of the original image and the aspect ratio of an image corresponding to the image input signals. Generally, when the aspect ratio of the original image is 16:9 and the aspect ratio of the image corresponding to the image input signals is 4:3, horizontally-spread invalid display regions are provided respectively on the top and bottom of the image corresponding to the image input signals. In contrast, when the aspect ratio of the original image is 4:3 and the aspect ratio of the image corresponding to the image input signals is 16:9, vertically-spread invalid display regions are provided respectively on the right and left of the image corresponding to the image input signals.

Hereinbelow, the invalid display region will be referred to as a black band region and signals corresponding to the invalid display region will be referred to as black-band-region signals, The black-band-region signals are signals for adjusting the aspect ratio of a valid image region and the aspect ratio of a display region within an image. The image input signals might include the black-band-region signals. Upon detection of the black-band-region signals in the image input signals, the image analyzer 350 notifies the projection element controller 340 and the signal corrector 360 of information for specifying the positions of the respective black-band-region signals in the image input signals.

The signal corrector 360 is configured to correct the image input signals and supply the corrected signals to the light source controller 370. When the second mode is selected, the signal corrector 360 changes the order of pixel signals included in the image input signals. Usually, in the image input signals, the pixel signals are arranged in such an order that the horizontal direction is the main scanning direction and the vertical direction is the sub scanning direction. In other words, it is assumed that scanning is performed as in the case of the first mode. For this reason, when the first mode is selected, the order of the pixel signals included in the image input signals does not need to be changed; however, when the second mode is selected, the order of the pixel signals needs to be changed in accordance with the scanning order of the second mode.

Moreover, if notified of the information for specifying the positions of the black-band-region signals from the image analyzer 350, the signal corrector 360 deletes the black-band-region signals from the image input signals and supplies the image input signals to the light source controller 370.

Moreover, the signal corrector 360 calculates power to be assigned to each of the multiple bands defined in the sub scanning direction, and sets the calculated power assignments for the projection element controller 340. A method of calculating the power assignments will be described later in detail.

Further, the signal corrector 360 is capable of compressing or expanding the image input signals in accordance with deletion of the black-band-region signals or calculated power assignments. More specifically, the signal corrector 360 performs thinning processing or interpolation processing on the pixel signals in the image input signals to thereby compress or expand the image input signals. For example, to compensate the deleted black-band-region signals, the image input signals after the deletion are expanded. Meanwhile, scanning in the sub scanning direction is slower in a band assigned larger power, but the scanning speed in the main scanning direction is constant. In such a band, therefore, it is necessary to oscillate the spot light in the main scanning direction larger number of times than the number of actual pixel lines. In this case, the signal corrector 360 expands the image input signals of that band in the sub scanning direction. Reversing this principle, for a band assigned smaller power, the signal corrector 360 compresses the image input signals of the band in the sub scanning direction.

Furthermore, the signal corrector 360 calculates signal gains for amplifying the luminance values of the image input signals included in each of the multiple bands defined in the sub scanning direction. With the signal gains, the signal corrector 360 amplifies the luminance values of the image input signals of the corresponding bands. This amplification processing is processing to cancel out changes in brightness of the bands in the sub scanning direction according to the power assignments, by amplification of the luminance values of the image input signals of the bands. For this reason, when importance is placed on increasing contrast, this amplification processing is not needed. Moreover, the luminance values of the image input signals of each of the bands may be amplified by using signal gains which partially cancel out changes in brightness of the bands. A method of calculating these signal gains will be described later in detail.

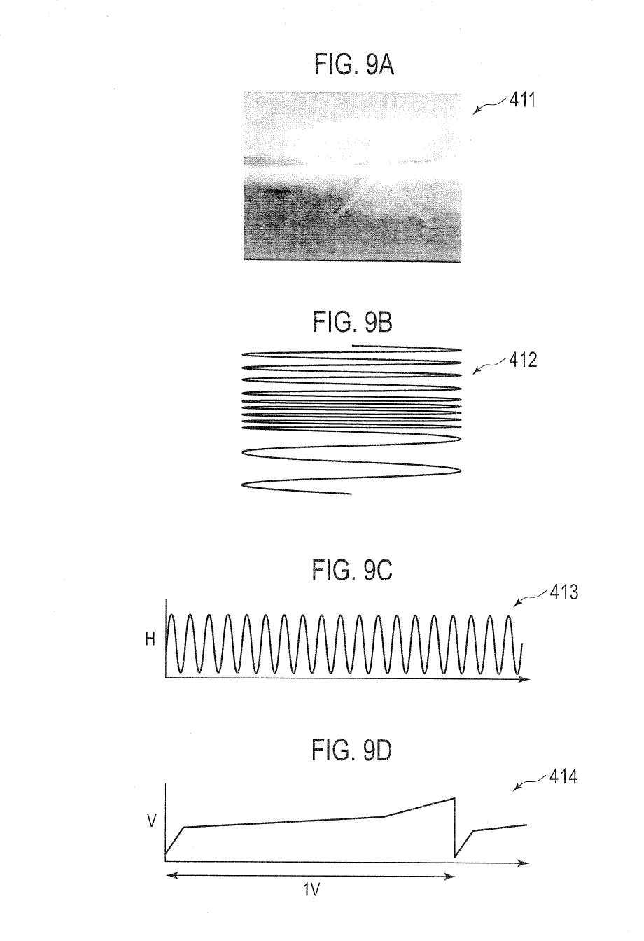

FIGS. 9A to 9D are an image, a diagram and graphs, respectively, for explaining the first mode. FIG. 9A shows an image 411 to be projected. The image 411 is an image in which black regions spread in the horizontal direction and substantially-black pixels spread relatively in the horizontal direction. Thus, scanning for the image 411 is performed in the first mode. FIG. 9B schematically shows a scanning trajectory 412 of spot light. Here, it is shown that the spot light has moved bottom to top along the scanning trajectory 412.

FIG. 9C shows a driving signal 413 of the horizontal-scanning projection element 320, and FIG. 9D shows a driving signal 414 of the vertical-scanning projection element 330. The horizontal axes each represent time, and the vertical axes each represent a current value supplied to the corresponding projection element. Incidentally, the vertical axes may be each considered. as the corresponding projection element's oscillation. angle controlled with the corresponding current value. “1V” shown in FIG. 9D represents a one-frame period. The driving signal 413 of the horizontal-scanning projection element 320 is a current value which varies at a resonance frequency.

The slope of the current value of the driving signal 414 of the vertical-scanning projection element 330, i.e., the oscillation speed of the vertical-scanning projection element 330, changes twice within the one-frame period. In the one-frame period, the oscillation speed is the highest in the first period, the lowest in the second period, and intermediate therebetween in the third period. These two changes in oscillation speed are reflected in the scanning trajectory 411, shown in FIG. 9B. It can be seen that, in the image 411, scanning is performed at the highest speed in the sub scanning direction in a lower region where the substantially-black pixels spread in a band shape in the horizontal direction, whereas scanning is performed at the lowest speed in the sub scanning direction in a center region where the sun is depicted.

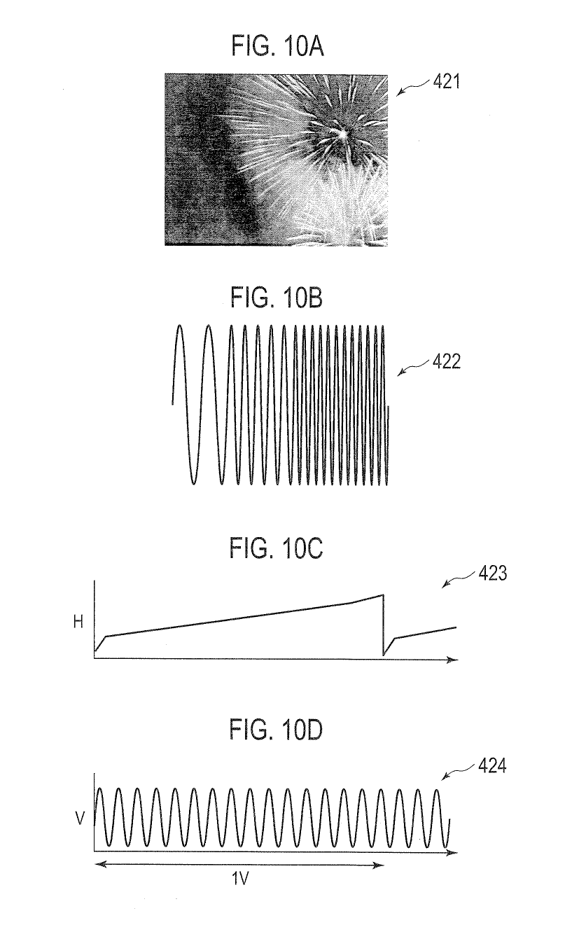

FIGS. 10A to 10D are an image, a diagram and graphs, respectively, for explaining the second mode. FIG. 10A shows an image 421 to be projected. The image 421 is an image in which black regions spread in the vertical direction and substantially-black pixels spread relatively in the vertical direction. Thus, scanning for the image 421 is performed in the second mode. FIG. 10B schematically shows a scanning trajectory 422 of spot light. Here, it is shown that the spot light has moved left to right along the scanning trajectory 422.

FIG. 10C shows a driving signal 423 of the horizontal-scanning projection element 320, and FIG. 10D shows a driving signal 424 of the vertical-scanning projection element 330. The slope of the current value of the driving signal 423 of the horizontal-scanning projection element 320, i.e., the oscillation speed of the horizontal-scanning projection element 320, changes once within a one-frame period. In the one-frame period, the oscillation speed is higher in the first period and lower in the second period. The driving signal 424 of the vertical-scanning projection element 330 is a current value which varies at a resonance frequency.

The change in oscillation speed is reflected in the scanning trajectory 422 shown in FIG. 10B. It can be seen that, in the image 421, scanning is performed at a higher speed in the sub scanning direction in a left region where the substantially-black pixels spread in a hand shape in the vertical direction, whereas scanning is performed at a lower speed in the sub scanning direction in a region from the center to the right where fireworks are depicted.

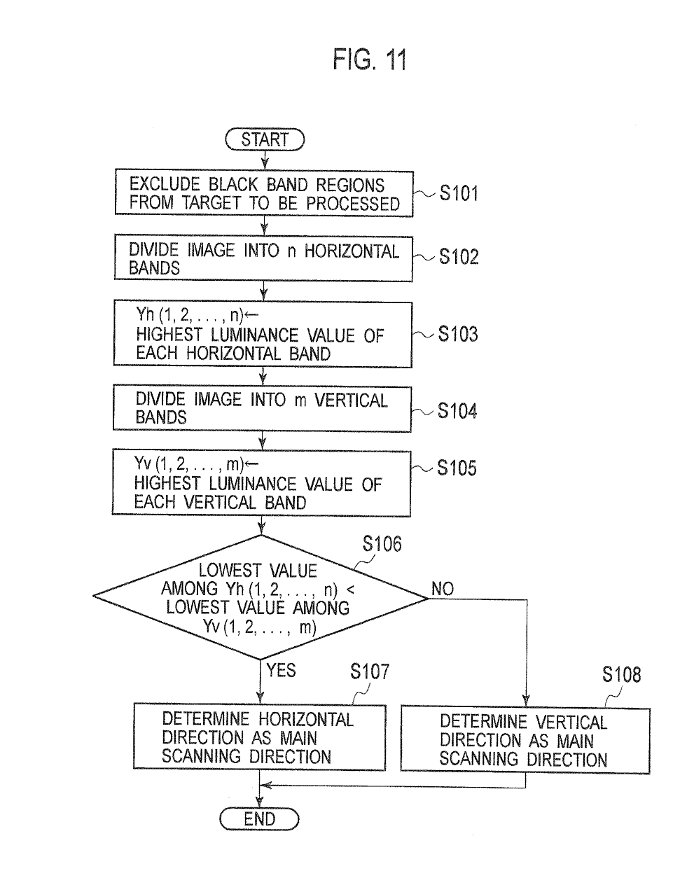

FIG. 11 is a flowchart for explaining image analysis processing by the image analyzer 350 according to the second embodiment. Firstly, the image analyzer 350 excludes black band regions out of a target to be processed subsequently, if there are black band regions included in an image produced by input images (S101). Next, the image analyzer 350 divides the resultant image into n (n is an integer not smaller than 2) horizontal bands (S102). Here, it is preferable to divide the image so that the horizontal bands would each have the same area, The image analyzer 350 specifies the highest luminance values Yh (1, 2, . . . , n) respectively of the horizontal bands, out of the luminance values of pixels included in the horizontal bands (S103).

Similarly, the image analyzer 850 divides the image into m (in is an integer not smaller than 2) vertical bands (S104). Here, it is preferable to divide the image so that the vertical bands would each have the same area. The image analyzer 850 specifies the highest luminance values Yv (1, 2, . . . , m) respectively of the vertical band, out of the luminance values of pixels included in the vertical bands (S105). m and n are preferably proportional to the screen aspect ratio of the image.

The image analyzer 350 compares the lowest value out of the highest values Yh (1, 2, . . . , n) of the horizontal bands, with the lowest value out of the highest values Yv (1, 2, . . . , m) of the vertical bands (S106). If the former is equal to or smaller than the latter (Y in S106), the image analyzer 350 determines the horizontal direction as the main, scanning direction (S107). If the former is larger than the latter (N in S106), the image analyzer 350 determines the vertical direction as the main scanning direction (S108). In other words, the lowest value out of the highest values Yh (1, 2, . . . , n) of the horizontal bands is a value representing the brightness of a band of the image that is presumed to be the darkest in the horizontal direction. In contrast, the lowest value out of the highest values Yv (1, 2, . . . , m) of the vertical bands is a value representing the brightness of a band of the image that is presumed to be the darkest in the vertical direction. Hence, whichever having a smaller value is judged as the direction in which darker regions spread, and that direction is determined as the main scanning direction.

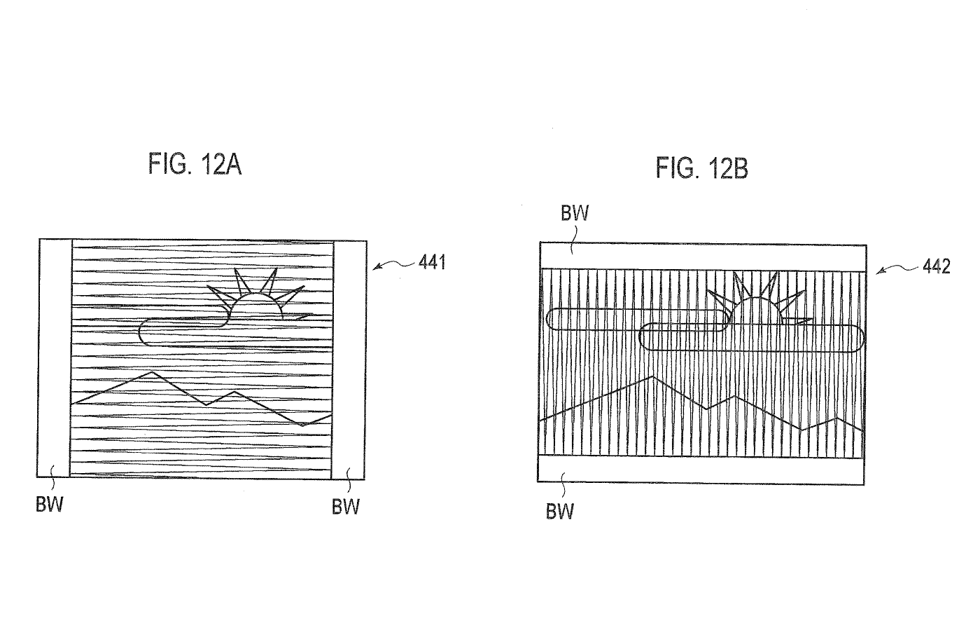

FIGS. 12A and 12B are diagrams for explaining the black band regions. Images have different screen aspect ratios, depending on their specifications. For example, screen aspect ratios of 4:3 or 16:9 have been standardized for an image. In some image input signals, the resolution is fixed to a certain screen aspect ratio, in order to neutralize the difference in screen aspect ratio. In a case where the screen aspect ratio is fixed and an image is lacking resolution, black band regions are inserted in the image.

FIG. 12A shows on image 441 in which black band regions BW are inserted, using a pillar-box format. The pillar-box format is a format to fit an image of a vertically long size into an image of a horizontally long size. FIG. 12B shows an image 442 in which black band regions BW are inserted, using a letter-box format. The letter-box format is a format to fit an image of a horizontally long size into an image of a vertically long size. In a case of a scanning-type laser projector, images can be displayed more efficiently if they are projected with black band regions excluded therefrom.

For this reason, if detected, the black band regions BW (invalid display regions) are excluded from the scanning fields of the projection elements (horizontal-scanning projection element 820 and vertical-scanning projection element 330). That is to say, the projection element controller 340 controls the projection elements (horizontal-scanning projection element 320 and vertical-scanning projection element 330) so that the projection elements would scan only a valid display region with the spot light in a projectable display region of the projection plane scannable with the spot light by the projection elements (horizontal-scanning projection element 320 and vertical-scanning projection element 330).

In such a case, signals (black-band-region signals) corresponding to the black band regions BW (invalid display regions) are not needed. The signal corrector 360 therefore removes the black-band-region signals, and performs interpolation of image input signals on the valid display region to thereby cover the lack of pixels. Consequently, it is possible to improve the definition of an image in the valid display region.

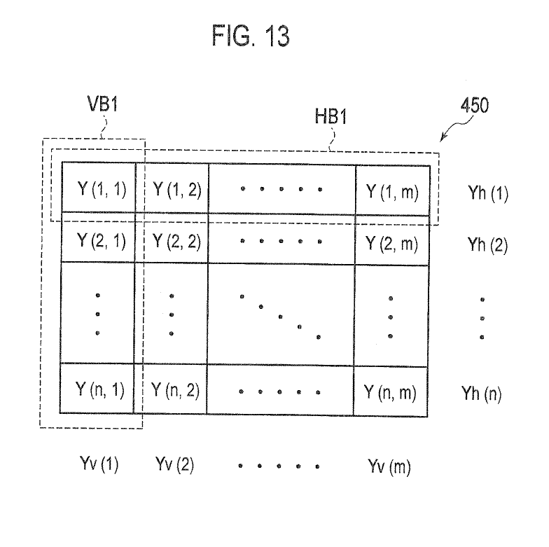

FIG. 13 is a diagram for explaining processing to divide an image 450 into multiple regions and processing to specify highest luminance values Yh respectively of horizontal bands HB and highest luminance values Yv respectively of vertical bands VB. The image 450 is divided into n horizontal bands HB. Among the luminance values of pixels included in each of the horizontal bands HB (1, 2, . . . , n), the highest luminance values are set as the highest luminance values Yh (1, 2, . . . , n) respectively of the horizontal bands BB (1, 2, . . . , n). Likewise, the image 450 is divided into in vertical bands VB. Among the luminance values of pixels included in each of the vertical bands VB (1, 2, . . . , m), the highest luminance values are set as the highest luminance values Yv (1, 2, . . . , m) respectively of the vertical bands VB (1, 2, . . . , n).

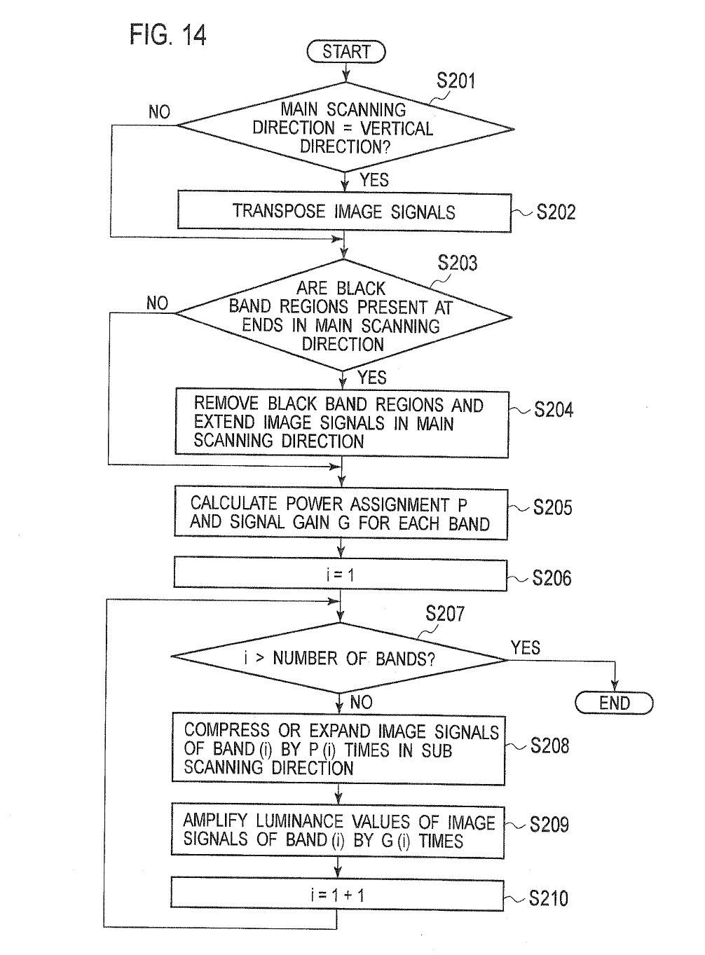

FIG. 14 is a flowchart for explaining image correction processing by the signal corrector 360 according to the second embodiment. Firstly, the signal corrector 360 judges whether the main scanning direction determined by the image analyzer 350 is the vertical direction or horizontal direction of an image (S201). If the main scanning is the vertical direction (Y in S201), the signal corrector 360 transposes target image input signals (S202). More specifically, the signal corrector 360 transposes the image input signals to change an arrangement for sequentially outputting horizontal pixel lines to an arrangement for sequentially outputting vertical pixel lines. If the result of the above judgment shows the horizontal direction (N in S201), the signal corrector 860 skips the process in Step S202.

Next, if black band regions are included in the image (Y in S203), the signal corrector 360 deletes black region signals of the black band regions. The signal corrector 360 then expands the resultant image input signals in the main scanning direction in order to fill the empty portions corresponding to the deleted black band regions (S204). Specifically, the scanning distance becomes shorter and the number of pixels runs short in the main scanning direction. Accordingly, the signal corrector 360 interpolates pixel signals in the main scanning direction in accordance with the ratio of the expansion. For each of the signals to be interpolated, it is possible to use a mean value of pixel signals of multiple pixels adjacent to a target pixel. If no black band regions are included in the image (N in S203), the signal corrector 360 skips the process in Step S204.

Next, the signal corrector 360 calculates power assignments P and signal gains G respectively for the bands defined in the sub scanning direction (S205). A concrete method for this calculation will be described later.

Next, 1 is substituted to a variable i in initial value setting (S206). If the variable i exceeds the number of the bands (Y in S207), the signal corrector 360 terminates the all the processes, and if not (N in S207), the signal corrector 360 performs processes in and after Step S208. Note that the number of the bands is m when the sub scanning direction is the horizontal direction, and is n when the sub scanning direction is the vertical direction.

The signal corrector 360 compresses or expands the image input signals of a band (i) in the sub scanning direction by a factor of P(i)(S208). If the value of P(i) is larger than 1, the signal corrector 360 expands the image input signals. If the value of P(i) is smaller than 1, the signal corrector 360 compresses the image input signals. For the expansion of the image input signals, it is possible to use the same method as that described above for the expansion of the image input signals in the main scanning direction. For the compression of the image input signals, the pixel signals of the band (i) are thinned in the sub scanning direction in accordance with the ratio of the compression.

The signal corrector 360 amplifies the luminance values of the image input signals of the band (i), more specifically, amplifies the luminance values of multiple pixel signals included in the image input signals by a factor of G(i)(S209). After finishing this process, the signal corrector 360 increments the variable i (S210), and transitions to the judging process in Step S207.

It should be noted here that, in the flowchart shown in FIG. 14, transposition of the image input signals is performed, using the process in S202. In other words, when the scanning mode is the first mode (main scanning=horizontal scanning), the power assignments (P) in the sub scanning direction are determined based on the ratios between the representative values of the brightness in the multiple band-shaped regions (bands) extending in the horizontal direction. In contrast, when the scanning mode is the second mode (main scanning=vertical scanning), the power assignments (P) in the sub scanning direction are determined based on the ratios between the representative values of the brightness in the multiple band-shaped regions (bands) extending in the vertical direction.

In addition, in the flowchart shown in FIG. 14, a relatively large value is set as the power assignment (P) for a band-shaped region having a representative value of relatively high brightness, and thus its image input signals are compressed. In contrast, a relatively small value is set as the power assignment (P) for a band-shaped region having a representative value of relatively low brightness, and thus its image input signals are expanded.

It should be noted that the scanning speed in the sub scanning direction is low when the power assignment (P) is relatively large, whereas the scanning speed in the sub scanning direction is high when the power assignment (P) is relatively small. In other words, the power assignment (P) may be considered as the inverse of the inclination of the current value shown in FIG. 9D or 10C.

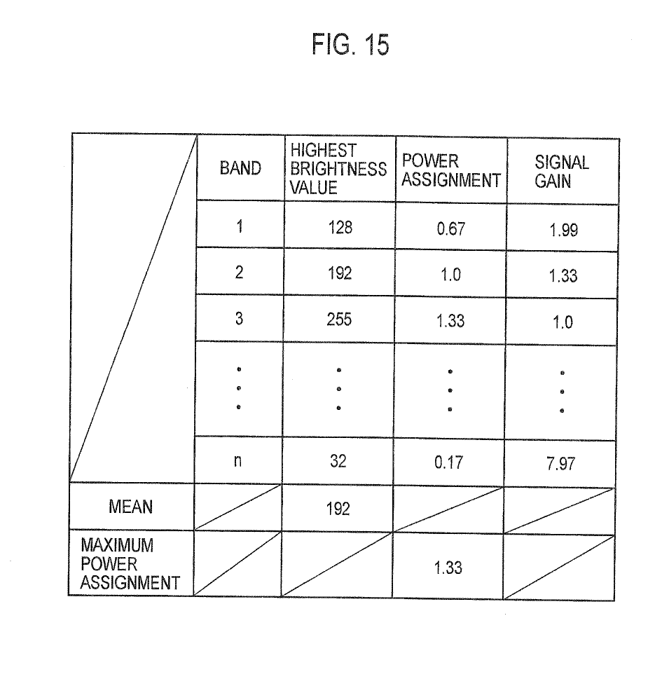

FIG. 15 is a table showing an example of calculation of the power assignment P and signal gain G for each of the bands. Here, description will, be given of an example where the sub scanning direction is determined to be the vertical direction. A target image is divided into n horizontal bands. The highest luminance values Yh (1, 2, . . . , n) respectively of the horizontal bands FEB are 128, 192, 255, . . . , 32, respectively. The mean value of the highest luminance values Yh (1, 2, . . . , n) is 192.

The power assignments P are each a value obtained by dividing the highest luminance value Yh(i) of the corresponding horizontal band HB(i) by the mean value of the highest luminance values (1, 2, . . . , n) of the horizontal bands HB (1, 2, . . . , n). The power assignments P (1, 2, . . . , n) of the horizontal bands HB (1, 2, . . . , n) are 0.67, 1.0, 1.33, . . . , 0.17, respectively. The signal gains G are each a value obtained by dividing the highest value of the power assignments P (1, 2, . . . , n) of the n horizontal bands HB (1, 2, . . . , n) by the power assignment P(i) of the corresponding horizontal band HB(i). Incidentally, the signal gains G may be adjusted through multiplication by a predetermined coefficient.

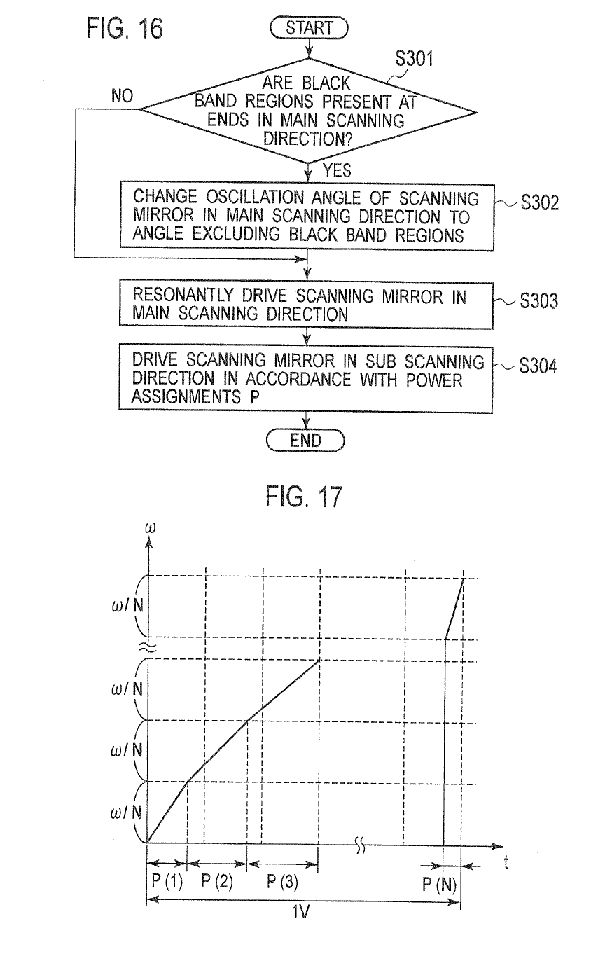

FIG. 16 is a flowchart for explaining drive processing for the horizontal-scanning projection element 320 and the vertical-scanning projection element 330 by the projection element controller 340, according to the second embodiment. First, if black band regions are included in a target image (Y in S301), the projection element controller 340 changes the oscillation angle of the projection element responsible for the main scanning direction, to an angle excluding the black band regions (S302). If no black band regions are included in the target image (N in S301), the projection element controller 340 skips the process in Step S302.

The projection element controller 340 resonantly drives the projection element responsible for the main scanning (S303). The projection element controller 340 drives the projection element responsible for the sub scanning, in accordance with the power assignments P (S304). The speeds at which the spot light passes on the multiple hands provided in the sub scanning direction are determined based respectively on the values of the power assignments P.

FIG. 17 is a graph for explaining an oscillation angle ω of the projection element responsible for the sub scanning. The horizontal axis represents time t and the vertical axis represents the oscillation angle ω. FIG. 17 refers to the calculated values in FIG. 15. The time required to pass on the bands provided in the sub scanning direction is determined in accordance with the power assignments P (1, 2, . . . , n) of the bands. Each ω/n represents the projection element's oscillation angle needed to project spot light corresponding to image input signals of the corresponding band. As can be seen from FIG. 17, it is shown that the third band is assigned larger power than those of the first and second bands.

### (Advantageous Effect)

As described above, according to the second embodiment, switching is appropriately performed between the first mode and the second mode. This improves the quality of an image to be projected, while suppressing an increase in power consumption. In other words, a direction where black regions are more dominating in the brightness distribution in an image is assigned to the main scanning direction where fast operation is necessary and thus detailed control is cult to be performed. This in turn allows a direction where more changes are present in the brightness distribution, to be assigned to the sub scanning direction where detailed control is possible. Accordingly, part of power to be assigned to a dark region can be transferred to a bright region. That is to say, light can be efficiently collected on a region where a more light amount is needed. Consequently, it is possible to improve the quality, especially contrast of an image without increasing power consumption.

### Modified Embodiments

The present invention has been described above based on some modes of the second embodiment. These modes of the second embodiment are just examples. Thus, it is to be understood by those skilled in the art that by combinations of the components and the processing thereof, various modifications are possible, and that such modifications are within the scope of the present invention.

In the second embodiment, the laser diode (LD) is raised as an example of the solid light source. However, the solid light source may be a light emitting diode (LED).

In the second embodiment described above, an example where the switching between the first mode and the second mode is performed in frame units is described. In a modification, the switching is performed in a unit shorter than a frame. The projection element controller 340 according to the modification switches between the first mode and the second mode during one frame of an image.

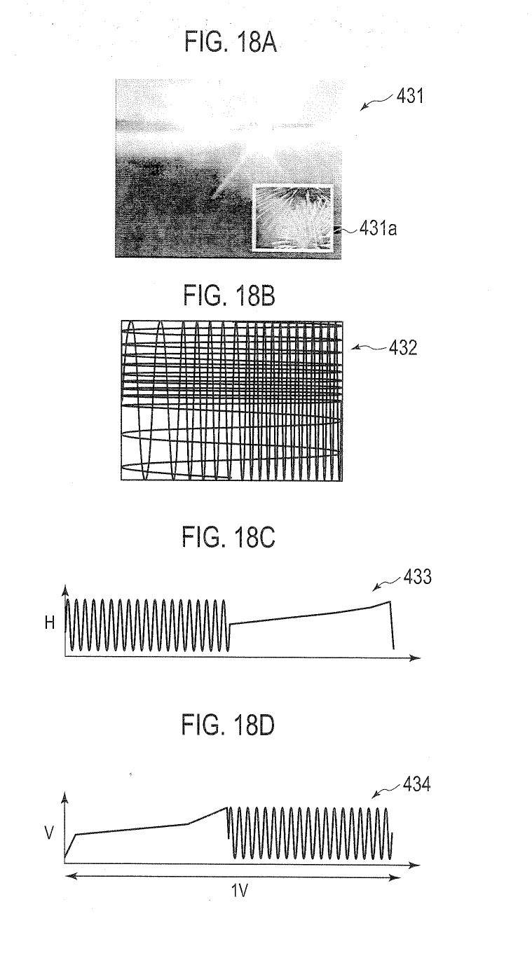

FIGS. 18A to 18D are an image, a diagram and graphs, respectively, for explaining the mode switching according to the modification. FIG. 18A shows an image 431 to be projected. The image 431 has a window 431a opened thereon. The image 431 is an image which is relatively bright on an upper right side and relatively dark on a lower left side. Scanning for the image 411 is performed in the first mode in the first half of one-frame period, and in the second mode in the second half of the period. FIG. 18B schematically shows scanning trajectories 432 of the spot light at the time of projecting the image 431. Here, it is shown that the spot light has moved bottom to top and left to right along the scanning trajectories 432.

FIG. 18C shows a driving signal 433 of the horizontal-scanning projection element 320, and FIG. 18D shows a driving signal 434 of the vertical-scanning projection element 434. It can be seen that the horizontal-scanning projection element 320 is caused to operate at a resonance frequency in. the first half of the one-frame period, and operate for periods of time based on the above-described power assignments, in the second half. In contrast, it can be seen that the vertical-scanning projection element 330 is caused to operate for periods of time based on the above-described power assignments, in the first half of the one-frame period, and operate at a resonance frequency in the second half. Scanning of the spot light along the scanning trajectories 432 shown in FIG. 18B can be performed in one-frame period if the scanning speed in the sub scanning direction is twice as high as the example shown in FIG. 9 or 10.

What is claimed is:

1. A projection image display apparatus including a solid light source, and a projection element configured to scan a projection plane with spot light emitted from the solid light source, the projection image display apparatus comprising:
an element controller configured to control a scanning speed of the projection element on the basis of an image input signal; and
a signal corrector configured to correct the image input signal on the basis of the scanning speed of the projection element controlled by the element controller.

2. The projection image display apparatus according to claim 1, further comprising a light source controller configured to control a spot diameter of is spot light to be emitted from the solid light source, on the basis of the scanning speed of the projection element controlled by the element controller.

3. The projection image display apparatus according to claim 1, further comprising an identifying unit configured to identify a high-frequency region in an image on the basis of the image input signal, the high-frequency region being a region including a high-frequency component, wherein
a reference scanning speed is set for the scanning speed of the projection element, and
the element controller controls the scanning speed of the projection element lower than the reference scanning speed in the high-frequency region, and controls the scanning speed of the projection element higher than the reference scanning speed outside the high-frequency region.

4. The projection image display apparatus according to claim 3, further comprising a light source controller configured to control a spot diameter of spot light to be emitted from the solid light source, on the basis of the scanning speed of the projection element controlled by the element controller, wherein
the light source controller reduces the spot diameter of the spot light to be emitted from the solid light source, in the high-frequency region.

5. The projection image display apparatus according to claim 1, wherein
the projection element includes
a horizontal-scanning projection element which scans the projection plane in a horizontal direction with the spot light emitted. from the solid light source, and
a vertical-scanning projection element which scans the projection plane in a vertical direction with the spot light emitted from the solid light source, and
the element controller controls
a first mode in which the horizontal-scanning projection element performs main scanning and the vertical-scanning projection element performs sub scanning, and
a second mode in which the vertical-scanning projection element performs the main scanning and the horizontal-scanning projection element performs the sub scanning.

6. The projection image display apparatus according to claim 5, further comprising an image analyzer configured to acquire distribution of brightness in an image, on the basis of the image input signal, wherein
the image analyzer selects any one of the first mode and the second mode in accordance with the distribution of brightness, and
the element controller controls the horizontal-scanning projection element and the vertical-canning projection element in accordance with the mode selected by the image analyzer.

7. The projection image display apparatus according to claim 6, wherein
when a black region spreads in the horizontal direction in the image, the image analyzer selects the first mode, and when a black region spreads in the vertical direction in the image, the image analyzer selects the second mode.

8. The projection image display apparatus according to claim 6, wherein
the image analyzer specifies a representative value of brightness in each of a plurality of band-shaped regions extending horizontally in the image in the first mode, and specifies a representative value of brightness in each of a plurality of band-shaped regions extending vertically in the image in the second mode, and
the element controller controls the sub scanning of the vertical-scanning projection element in accordance with a ratio between the representative values of brightness in the plurality of band-shaped regions extending horizontally in the first mode, and controls the sub scanning of the horizontal-scanning projection element in accordance with a ratio between the representative values of brightness in the plurality of band-shaped regions extending vertically in the second mode.

9. The projection image display apparatus according to claim 5, wherein
the image analyzer specifies a valid display region and an invalid display region in a projectable display region which is a region of the projection plane scannable with the spot light by the projection element, and
the element controller controls the projection elements so that the projection elements scan the valid display region in the projectable display region excluding the invalid display region.

10. The projection image display apparatus according to claim 7, wherein, when the projection elements are controlled to scan the valid display region except the invalid display region, the signal corrector removes the image input signal corresponding to the invalid display region and performs interpolation on the image input signal corresponding to the valid display region.

11. The projection image display apparatus according to claim 5, wherein the element controller switches between the first mode and the second mode frame by frame.
